(19) United States
(12) Patent Application Publication
(10) Pub. No.: US 2016/0072155 A1
(43) Pub. Date: Mar. 10, 2016

(54) BATTERY PACK

(71) Applicant: Samsung SDI Co., LTD., Yongin-si (KR)

(72) Inventor: Han-Kyu Park, Yongin-si (KR)

(21) Appl. No.: 14/832,987

(22) Filed: Aug. 21, 2015

(30) Foreign Application Priority Data
Sep. 4, 2014 (KR) 10-2014-0117673

(51) Int. Cl. H01M 10/42; H01M 2/10; H01M 2/30

(52) U.S. Cl. CPC H01M 10/425; H01M 2/30; H01M 2/105; H01M 2010/4271; H01M 2220/30

(57) ABSTRACT

A battery pack is disclosed. In one aspect, the battery pack includes a plurality of bare cells connected in series or in parallel and a protective circuit module electrically connected to the bare cells and including a plurality of circuit components on a first surface thereof. The battery pack also includes a plurality of terminals formed on the first surface of the protective circuit module and configured to be electrically connected to an external device. At least one of the terminals is spaced apart from the first surface of the protective circuit module and wherein at least one of the circuit components is formed between the at least one terminal and the first surface of the protective circuit module.

### CROSS-REFERENCE TO RELATED APPLICATIONS

This application claims priority to and the benefit of Korean Patent Application No. 10-2014-0117673, filed on Sep. 4, 2014, in the Korean Intellectual Property Office, the entire contents of which are incorporated herein by reference in their entirety.

### BACKGROUND

1. Field

The described technology generally relates to a battery pack.

2. Description of the Related Technology

Recently, various battery packs are used as a power source of portable electronic devices. In addition, as the portable devices are used in various fields, demand for battery packs has rapidly increased. Since battery packs can be charged and discharged so as to be used a plurality of times and are effective economically and environmentally, the use of battery packs is promoted.

Portable electronic devices are desirable to be small in size and light in weight, battery packs are also required to be small and light. However, battery packs include a material having high reactivity such as lithium, or the like, therein, and thus, there is a limitation in reducing a size and weight of battery packs in terms of stability. Thus, research into development a battery pack having enhanced stability has been variously conducted.

### SUMMARY OF CERTAIN INVENTIVE ASPECTS

One inventive aspect is a small and lightweight battery pack.

Another aspect is a battery pack having enhanced space efficiency of a space in which circuit components, or the like, are installed.

Another aspect is a battery pack which includes a plurality of bare cells connected in series or in parallel; a protective circuit module electrically connected to the plurality of bare cells and having a plurality of circuit components on a first surface thereof; and at least terminals provided on the first surface of the protective circuit module and electrically connected to an external device, wherein at least some of the terminals are spaced apart from the first surface of the protective circuit module and at least circuit components are provided between the terminals and the first surface of the protective circuit module.

The terminals may include at least clip portions electrically connected to an external device, base portions supporting the clip portions, and coupling portions respectively extending from one end and the other end of the base portions to electrically couple the terminals to the bare cells or the protective circuit module.

At least some of the base portions may be spaced apart from the first surface of the protective circuit module to form a space S, and at least the circuit components may be provided in the space S.

At least some of the base portions may be spaced apart from the first surface of the protective circuit module to form a space S, and the base portions may further include at least ribs extending to traverse the space.

A rib installation portion in contact with the ribs may be provided on the first surface.

At least some of the base portions may be spaced apart from the first surface of the protective circuit module to form a space, and at least component mounting portions on which circuit component are mounted may be provided on the first surface of the portion where the space is formed.

The base portions may include a plate provided to be parallel to the first surface of the protective circuit module and a bent portion extending from at least a portion of the plate and bent toward the first surface.

The clip portions may be provided on a surface of the plate opposite a surface facing the first surface of the protective module.

Each of the coupling portions may extend from end of the bent portion.

The plate may include a first portion spaced apart from the first surface of the protective circuit module and a second portion bent from one end of the first portion and contacting the first surface.

The other end of the first portion may sequentially have the bent portion and the coupling portion.

A second portion firstly bent from the first portion toward the first surface of the protective circuit module and secondly bent to be parallel with the first surface and contacting the first surface may be connected to one end of the first portion, and the second portion may sequentially have the bent portion and the coupling portion.

One end of the second portion may be connected to the first portion, the other end of the second portion may be connected to the bent portion, and a flange portion may be provided on the side of the second portion and bent from the side of the second portion such that the flange faces the corner of the protective circuit module.

At least some of the plurality of bare cells may be aligned in one direction such that the sides thereof go abreast, and the protective circuit module may be provided on the aligned sides of the bare cells such that the first surface thereof faces in the opposite direction of the bare cells. The plurality of bare cells may further include a housing provided to correspond to the shape of the bare cells to fix the plurality of bare cells to a single unit.

Another aspect is a battery pack comprising: a plurality of bare cells connected in series or in parallel; a protective circuit module electrically connected to the bare cells and including a plurality of circuit components on a first surface thereof; and a plurality of terminals formed on the first surface of the protective circuit module and configured to be electrically connected to an external device, wherein at least one of the terminals is spaced apart from the first surface of the protective circuit module and wherein at least one of the circuit components is formed between the at least one terminal and the first surface of the protective circuit module.

In the above battery pack, the terminals include a plurality of clip portions configured to be electrically connected to an external device, a plurality of base portions supporting the clip portions, and a plurality of coupling portions respectively extending from opposing ends of the base portions to electrically connect the terminals to the bare cells or the protective circuit module. In the above battery pack, at least some of the base portions are spaced apart from the first surface of the protective circuit module to form a space S, and wherein the at least one circuit component is located in the space S. In the above battery pack, at least some of the base portions are spaced apart from the first surface of the protective circuit module to form a space S, and wherein the base portions further include a plurality of ribs extending to traverse the space.

The above battery pack further comprises a rib installation portion in contact with the ribs and located on the first surface. In the above battery pack, at least some of the base portions are spaced apart from the first surface of the protective circuit module to form a space, and wherein the battery pack further comprises a plurality of component mounting portions accommodating the circuit components and located on the first surface of the portion where the space is formed.

In the above battery pack, each of the base portions includes a plate formed to be substantially parallel to the first surface of the protective circuit module and a bent portion extending from at least a portion of the plate and bent toward the first surface. In the above battery pack, the clip portions are located on a surface of the plate opposite a surface facing the first surface of the protective module. In the above battery pack, each of the coupling portions extends from an end of the bent portion. In the above battery pack, the plate includes a first portion spaced apart from the first surface of the protective circuit module and a second portion bent from one end of the first portion and contacting the first surface.

In the above battery pack, another end of the first portion is connected to the corresponding bent and coupling portions. In the above battery pack, the second portion is firstly bent from the first portion toward the first surface of the protective circuit module and secondly bent to be substantially parallel to the first surface and wherein the second portion is connected to the corresponding bent and coupling portions. In the above battery pack, one end of the second portion is connected to the first portion, wherein another end of the second portion is connected to the bent portion, and wherein a flange portion is formed on a side of the second portion and bent from the side of the second portion such that the flange faces a corner of the protective circuit module. In the above battery pack, the protective circuit module is located above the bare cells such that the first surface does not face the bare cells. In the above battery pack, the bare cells further include a housing substantially corresponding to the shape of the bare cells to fix the bare cells to a single unit.

Another aspect is a battery pack comprising: a plurality of bare cells; a protective circuit module electrically connected to the bare cells and including a plurality of circuit components on a first surface thereof; and a plurality of terminals formed on the first surface of the protective circuit module and configured to be electrically connected to an external device, wherein a gap is formed between at least one of the terminals and the first surface of the protective circuit module and wherein at least one of the circuit components is formed in the gap.

In the above battery pack, the terminals include a plurality of clip portions configured to be electrically connected to an external device, a plurality of base portions supporting the clip portions, and a plurality of coupling portions respectively extending from opposing ends of the base portions to electrically connect the terminals to the bare cells or the protective circuit module. In the above battery pack, at least some of the base portions are spaced apart from the first surface of the protective circuit module to form the gap. In the above battery pack, at least some of the base portions are spaced apart from the first surface of the protective circuit module to form the gap, and wherein the base portions further include a plurality of ribs extending to traverse the gap. In the above battery pack, at least some of the base portions are spaced apart from the first surface of the protective circuit module to form the gap, and wherein the battery pack further comprises a plurality of component mounting portions accommodating the circuit components and located on the first surface of the portion where the gap is formed.

According to at least one of the disclosed embodiments, a small and lightweight battery pack can be provided.

In addition, according to the present invention, a battery pack having enhanced space efficiency of a space in which circuit components, and the like, are installed can be provided.

### BRIEF DESCRIPTION OF THE DRAWINGS

FIG. 1 is a perspective view illustrating a battery pack according to an embodiment.

FIG. 2 is a view schematically illustrating a terminal and a protective circuit module of FIG. 1.

FIG. 3 is an exploded perspective view of FIG. 2.

FIG. 4 is a perspective view of a protective circuit module according to another embodiment.

FIG. 5 is a view schematically illustrating a terminal and a protective circuit module according to another embodiment.

FIG. 6 is an exploded perspective view of FIG. 5.

FIG. 7 is a view schematically illustrating a terminal and a protective circuit module according to another embodiment.

### DETAILED DESCRIPTION OF CERTAIN INVENTIVE EMBODIMENTS

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will full convey the scope of the example embodiments to those skilled in the art. Like reference numerals refer to like elements throughout.

Hereinafter, embodiments of the present invention will be described in detail with reference to the accompanying drawings.

The advantages and features of the described technology and methods for achieving these will be clarified in detail through embodiments described hereinafter in conjunction with the accompanying drawings. However, the disclosed embodiments may, however, be implemented in many different forms and should not be construed as being limited to the embodiments set forth herein, and in the following description, it is to be understood that when one element is referred to as being “connected to” or “connected to” another element, it may be connected directly to or connected directly to another element or be connected to or connected to another element, having the other element intervening therebetween. Accordingly, the drawings and description are to be regarded as illustrative in nature and not restrictive. Like reference numerals designate like elements throughout the specification.

Hereinafter, embodiments will be described with reference to the accompanying drawings. In this disclosure, the term “substantially” includes the meanings of completely, almost completely or to any significant degree under some applications and in accordance with those skilled in the art. Moreover, “formed on” can also mean “formed over.” The term “connected” includes an electrical connection.

FIG. 1 is a perspective view illustrating a battery pack 100 according to an embodiment.

The battery pack 100 includes a plurality of bare cells 10 connected in series or in parallel, a protective circuit module 110 and at least terminals 120. The protective circuit module 110 can be electrically connected to the bare cells 10 and have a plurality of circuit components 112 on a first surface 111 thereof. The terminals 120 can be provided on the first surface 111 of the protective circuit module 110 and electrically connected to an external device. In some embodiments, at least some of the terminals 120 are spaced apart from the first surface 111 of the protective circuit module 110 and at least circuit components 112 are provided between the terminals 120 and the first surface 111 of the protective circuit module 110.

The bare cells 10 may be a cylindrical secondary battery including an anode and a cathode and may be aligned to be electrically connected to each other. At least some of the bare cells 10 can be aligned in one direction such that the sides thereof go abreast. Furthermore, the protective circuit module 110 may be provided on the aligned sides of the bare cells 10 such that the first surface 111 thereof faces in the opposite direction of the bare cells 10. In addition, the bare cells 10 may further include a housing 40 provided to substantially correspond to the shape of the bare cells 10 to fix the bare cells 10 to a single unit.

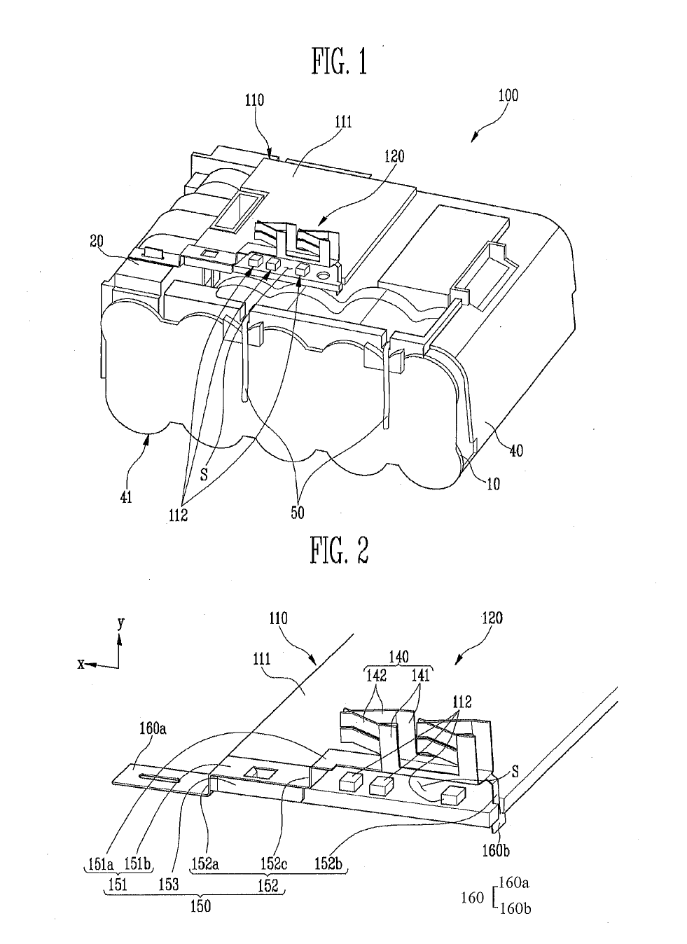

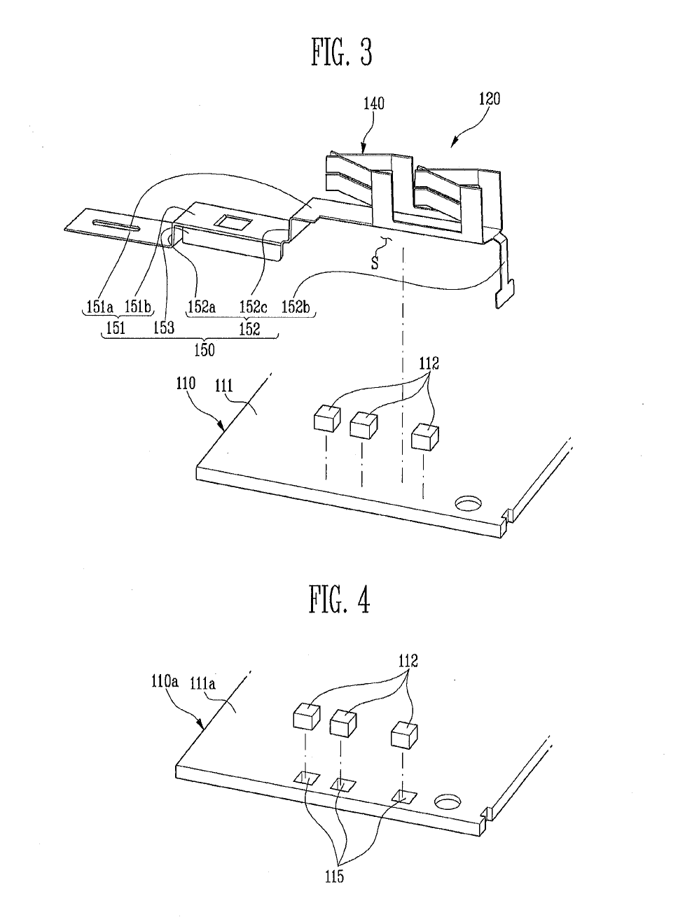

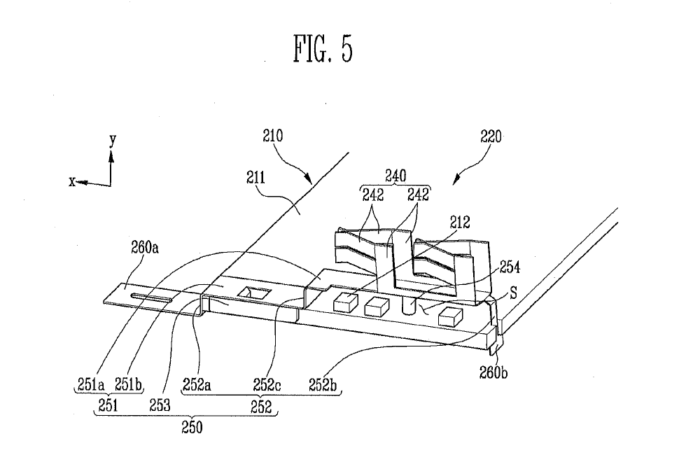

Referring to FIG. 1, in the case of the cylindrical secondary battery, the sides of the bare cells 10 may be substantially aligned in a mutually facing manner such that an upper side or a lower side of the bare cells 10 are substantially flat. The sides of the bare cells 10 can be rounded, and thus, the bare cells 10 may move and the housing 40 may be provided to substantially correspond to the shape of the bare cells 10 to fix the bare cells 10 to a single unit. The upper side or the lower side of the bare cells 10 may be covered by an insulating sheet 41 to prevent a short-circuit, and the bare cells 10 may be electrically connected to the terminal 120 through a large current terminal 20. In addition, the battery pack 100 may include at least wires 50 to monitor a state such as voltage, current, and the like, of the bare cells 10, and the wires 10 may transmit the state of the bare cells 10 to the protective circuit module 110. Hereinafter, the terminal 120 and the protective circuit module 110 according to this embodiment will be described with reference to FIGS. 2 and 3.

FIG. 2 is a view schematically illustrating a terminal and a protective circuit module of FIG. 1, and FIG. 3 is an exploded perspective view of FIG. 2.

Referring to FIGS. 2 and 3, each of the terminals 120 may include at least clip portions 140 electrically connected to an external device, base portions 150 supporting the clip portions 140, and coupling portions 160 respectively extending from one end and the other end of the base portions 150 to electrically couple the terminal 120 to the bare cells 10 (See FIG. 1) or the protective circuit module 110. At least some of the base portions 150 may be spaced apart from the first surface 111 of the protective circuit module 110 to form a space S, and at least the circuit components 112 may be provided in the space S.

In general, a predetermined number or more of circuit components may be installed or mounted on the protective circuit module during a process of manufacturing a battery pack, and the circuit components may be disposed in the vicinity of the terminal provided on the protective circuit module and connected by using soldering, or the like. In case of forming a complicated circuit within a limited area of the size of the protective circuit module, a plurality of circuit components need to be mounted, and here, the terminal occupies a large portion of the area of the protective circuit module, causing a problem. In addition, if the area of the protective circuit module is increased to solve the problem, the size and weight of the battery pack may be increased, and when the circuit modules are densely provided, an error may occur when the circuit is driven.

In some embodiments, the terminal having a new structure is provided to increase a space in which circuit components are installed in the protective circuit module, without having to increase the area of the protective circuit module. In addition, important circuit components, or the like, may be provided between the terminal and the protective circuit module so as to be covered and protected.

The terminal 120 may include the clip portions 140 electrically connected to an external device, the base portions 150 supporting the clip portions 140 and provided to be substantially parallel on the first surface 111 of the protective circuit module 110, and the coupling portions 160a and 160b extending from the base portions 150 and electrically connected to the protective circuit module 110 or the bare cells 10.

The clip portions 140 may be provided on a plate 151, and here, the clip portions 140 may be provided on a surface of the plate 151 opposite a surface facing the first surface 111 of the protective circuit module 110. The clip portions 140 may include extending portions 141 extending to be substantially parallel in a y direction from the plate 150 and head portions 142 extending to be substantially parallel in an x direction from the extending portions 141 and clamped to an external device. At least clip portions 140 may be provided, and in this case, the head portions 142 respectively provided in the clip portions 140 may face in substantially the same direction.

The base portions 150 may include the plate 151 provided to be substantially parallel with the first surface 111 of the protective circuit module 110 and a bent portion 152 extending from at least a portion of the plate 150 and bent toward the first surface 111. At least bent portions 152 bent and extending from one end and the other end of the plate 151 may be provided in the base portions 150. In addition, the coupling portions 160 may extend from an end of the bent portion 152.

The plate 151 may include a first portion 151 a spaced apart from the first surface 111 of the protective circuit module 110 and a second portion 151b bent from one end of the first portion 151a and contacting the first surface 111 The first and second portions 151a and 151b of the plate 151 may extend to be substantially parallel to the first surface 111 of the protective circuit module 110, and the first portion 151a may be spaced apart from the first surface 111 and the second portion 151b may be in contact with the first surface. In addition, the bent portion 152b and the coupling portion 160b may be provided in the other end of the first portion 151a, for example, on the opposite side of the one end to which the second portion 151b is connected.

The first portion 151a may be spaced apart from the first surface 111 of the protective circuit module 110 to form the space S, and the second portion 151b may be in contact with the first surface 111 of the protective circuit module 110. That is, the circuit components 112 mounted on the protective circuit module 110 may be installed in the space S formed by the first portion 151a of the plate 151 in the terminal 120, and the second portion 151b of the plate 151 may be in contact with the protective circuit module 110 to stably support the terminal 120.

That is, a bend portion 152c firstly bent from the first portion 151a toward the first surface 111 of the protective circuit module 110 and secondly bent to be substantially parallel with the first surface 111 is formed at one end of the first portion 151a. The second portion 151b in contact with the first surface 111 is connected to the bend portion 152c. The second portion 151b may sequentially have the bent portion 152a and the coupling portion 160a. In addition, one end of the second portion 151b may be connected to the first portion 151b, and the other end of the second portion 151b may be connected to the bent portion 152a. A flange portion 153 may be provided on the side of the second portion 151b such that it is adjacent to the bent portion 152a. The flange portion 153 may be bent from the side of the second portion 151b to face the corner of the protective circuit module 110.

The terminal 120 may be fixed to the protective circuit module 110. In a portion of the terminal 120 connected to the first portion 151a, a concave recess may be formed in the corner of the protective circuit module such that it corresponds to the size of the bent portion 152b in the protective circuit module 110 to fix the position of the terminal 120. Furthermore, a portion of the terminal 120 connected to the second portion 151b may be reversibly connected to the protective circuit module 110 by the second portion 151b and the bent portion 152a extending from the second portion 151b, and the flange portion 153 to easily align and fix the terminal 120.

FIG. 4 is a perspective view of a protective circuit module according to another embodiment.

Referring to FIG. 4, a protective circuit module 110a may include at least component mounting portions 115. For example, at least a portion of the base portion of the terminal may be spaced apart from the first surface 111a of the protective circuit module 110a to form a space, and the component mounting portions 115 may be provided and mounted on the first surface 111a of the portion where the space is formed. The component mounting portions 115 may be provided on the first surface 111 of the protective circuit module 110a to guide positions in which the circuit components 112 are mounted. In addition, the component mounting portions 115 may be formed as grooves or openings, for example. At least some of the circuit components 112 may be inserted and fixed in the component mounting portions 115, whereby the circuit components 112 can be stably fixed, and soldering, or the like, can be easily performed.

As described above, in the battery pack according to these embodiments, the area of the protective circuit module can be effectively used, and thus, a mounting area of circuit components, or the like, can be increased. In addition, since the size of the protective circuit module is effectively reduced, the battery pack can be reduced in size and weight. In the battery pack according to these embodiments, the terminal may be easily aligned and fixed on the protective circuit module, and at least some circuit components may be provided between the terminal and the protective circuit module so as to be covered and protected.

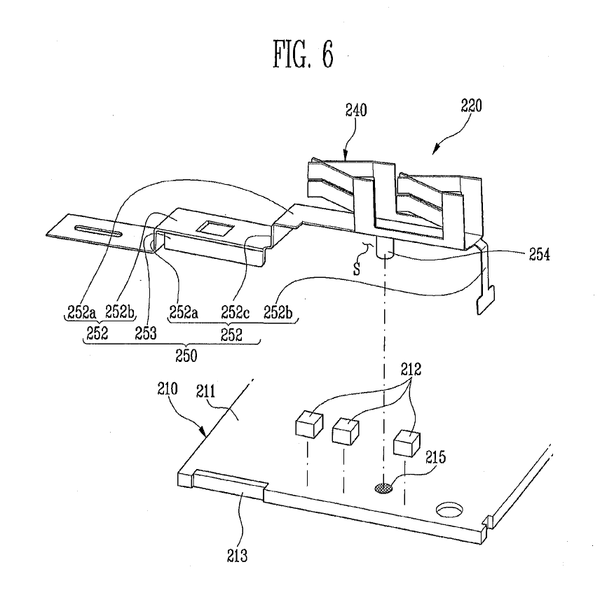

Hereinafter, another embodiment will be described with reference to FIGS. 5 through 7. Except for the contents described hereinafter, other components are similar to the contents described above in the former embodiment, and thus, details thereof will be omitted.

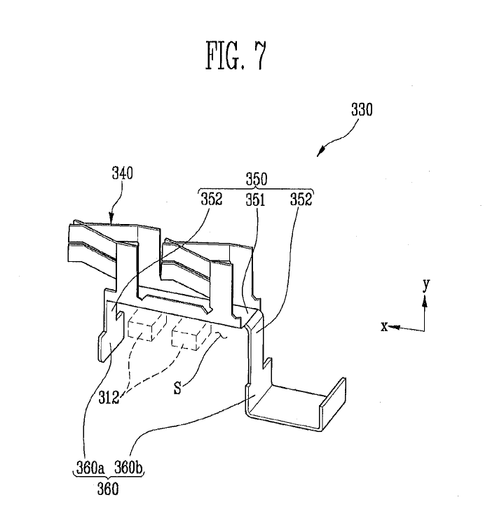

FIG. 5 is a view schematically illustrating a terminal and a protective circuit module according to another embodiment, and FIG. 6 is an exploded perspective view of FIG. 5.

Referring to FIGS. 5 and 6, a battery pack according to this embodiment includes a protective circuit module 210 and a terminal 220 provided on a first surface 211 of the protective circuit module 210. The terminal 220 may include clip portions 240 electrically connecting the battery pack to an external device and coming into direct contact with the external device, base portions 250 supporting the clip portions 240, and coupling portions 260a and 260b respectively connected to ends of the base portions 250 and electrically connected to a bare cell or a protective circuit module.

At least some of the base portions 250 may be spaced apart from the first surface 211 of the protective circuit module 210 to form a space S, and the base portions 250 may further include at least ribs 254 extending to traverse the space S. The ribs 254 may extend toward the first surface 211 of the protective circuit module 210 from the base portions 250. At least circuit components 212 may be provided in the space S.

The base portions 250 may include a plate 251 in substantially parallel with the first surface 211 of the protective circuit module 210, at least bent portions 252 extending to be substantially parallel in a direction (x direction) in which the plate 251 extends, and bent toward the first surface 211, and a flange portion 253 extending in a direction crossing or substantially perpendicular to the bent portion 252 from the plate 251. The plate 251 may include a first portion 251a spaced apart from the first surface 211 and having the space S and a second portion 251b extending from the first portion 251a so as to be in contact with the first surface 211. In addition, the bent portion 252 may include a portion 252a connected to an end of the second portion 251b, a portion 252b connected to an end of the first portion, and a portion 252c coupling the first and second portions.

The ribs 252 may be provided in the first portion 251a of the plate 251 of the base portions 250. The ribs 252 may support the first portion 251a of the plate 251 to stably maintain the space S between the first surface S of the protective circuit module 210.

In addition, the first surface 211 of the protective circuit module 210 may have a rib installation portion 215 provided on the first surface 211 and contacting the rib 254. The rib installation portion 215 may be provided in a position corresponding to the rib 254 to easily guide the position of the rib 254 and firmly install the rib 254 to the first surface 211. For example, the rib installation portion 215 may have an even surface or may be provided in an inwardly concave form on the first surface 211 of the protective circuit module 210 to allow a portion of the rib 254 to be inserted therein.

FIG. 7 is a view schematically illustrating a terminal and a protective circuit module according to another embodiment.

FIG. 7 is a view illustrating a shape of a terminal 330 according to another embodiment. The terminal 330 may form a space S spaced apart from the first surface of the protective circuit module, and circuit components 312 may be provided in the space S, enhancing space efficiency of the protective circuit module. The terminal 330 may include clip portions 340 that may be connected to an external device, base portions 350 provided to cover the circuit components 312, and coupling portions 360 extending from ends of the base portions 350 and electrically connected to a bare cell or the protective circuit module. The coupling portions 360 may be variously modified according to a structure of an adjacent portion, to be provided as coupling portions 360a and 360b.

The base portions 350 may include a plate 351 provided to be substantially parallel to the protective circuit module and a bent portion 352 substantially vertically bent from the plate 351, and the coupling portions 360 may extend from the bent portion 352. In the terminal 300 according to this embodiment, the plate 351 is spaced apart from the protective circuit module overall to form a space, and the plate 351 may be formed not to have a surface in contact with the protective circuit module.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack comprising:
a plurality of bare cells connected in series or in parallel;
a protective circuit module electrically connected to the bare cells and including a plurality of circuit components on a first surface thereof; and
a plurality of terminals formed on the first surface of the protective circuit module and configured to be electrically connected to an external device,
wherein at least one of the terminals is spaced apart from the first surface of the protective circuit module and wherein at least one of the circuit components is formed between the at least one terminal and the first surface of the protective circuit module.

2. The battery pack as claimed in claim 1, wherein the terminals include a plurality of clip portions configured to be electrically connected to an external device, a plurality of base portions supporting the clip portions, and a plurality of coupling portions respectively extending from opposing ends of the base portions to electrically connect the terminals to the bare cells or the protective circuit module.

3. The battery pack as claimed in claim 2, wherein at least some of the base portions are spaced apart from the first surface of the protective circuit module to form a space S, and wherein the at least one circuit component is located in the space S.

4. The battery pack as claimed in claim 2, wherein at least some of the base portions are spaced apart from the first surface of the protective circuit module to form a space S, and wherein the base portions further include a plurality of ribs extending to traverse the space.

5. The battery pack as claimed in claim 4, further comprising a rib installation portion in contact with the ribs and located on the first surface.

6. The battery pack as claimed in claim 2, wherein at least some of the base portions are spaced apart from the first surface of the protective circuit module to form a space, and wherein the battery pack further comprises a plurality of component mounting portions accommodating the circuit components and located on the first surface of the portion where the space is formed.

7. The battery pack as claimed in claim 3, wherein each of the base portions includes a plate formed to be substantially parallel to the first surface of the protective circuit module and a bent portion extending from at least a portion of the plate and bent toward the first surface.

8. The battery pack as claimed in claim 7, wherein the clip portions are located on a surface of the plate opposite a surface facing the first surface of the protective module.

9. The battery pack as claimed in claim 7, wherein each of the coupling portions extends from an end of the bent portion.

10. The battery pack as claimed in claim 7, wherein the plate includes a first portion spaced apart from the first surface of the protective circuit module and a second portion bent from one end of the first portion and contacting the first surface.

11. The battery pack as claimed in claim 10, wherein another end of the first portion is connected to the corresponding bent and coupling portions.

12. The battery pack as claimed in claim 10, wherein the second portion is firstly bent from the first portion toward the first surface of the protective circuit module and secondly bent to be substantially parallel to the first surface and wherein the second portion is connected to the corresponding bent and coupling portions.

13. The battery pack as claimed in claim 12, wherein one end of the second portion is connected to the first portion, wherein another end of the second portion is connected to the bent portion, and wherein a flange portion is formed on a side of the second portion and bent from the side of the second portion such that the flange faces a corner of the protective circuit module.

14. The battery pack as claimed in claim 1, wherein the protective circuit module is located above the bare cells such that the first surface does not face the bare cells.

15. The battery pack as claimed in claim 1, wherein the bare cells further include a housing substantially corresponding to the shape of the bare cells to fix the bare cells to a single unit.

16. A battery pack comprising:
a plurality of bare cells;
a protective circuit module electrically connected to the bare cells and including a plurality of circuit components on a first surface thereof; and
a plurality of terminals formed on the first surface of the protective circuit module and configured to be electrically connected to an external device,
wherein a gap is formed between at least one of the terminals and the first surface of the protective circuit module and wherein at least one of the circuit components is formed in the gap.

17. The battery pack as claimed in claim 16, wherein the terminals include a plurality of clip portions configured to be electrically connected to an external device, a plurality of base portions supporting the clip portions, and a plurality of coupling portions respectively extending from opposing ends of the base portions to electrically connect the terminals to the bare cells or the protective circuit module.

18. The battery pack as claimed in claim 17, wherein at least some of the base portions are spaced apart from the first surface of the protective circuit module to form the gap.

19. The battery pack as claimed in claim 17, wherein at least some of the base portions are spaced apart from the first surface of the protective circuit module to form the gap, and wherein the base portions further include a plurality of ribs extending to traverse the gap.

20. The battery pack as claimed in claim 17, wherein at least some of the base portions are spaced apart from the first surface of the protective circuit module to form the gap, and wherein the battery pack further comprises a plurality of component mounting portions accommodating the circuit components and located on the first surface of the portion where the gap is formed.
